(19) United States
(12) Patent Application Publication
(10) Pub. No.: US 2006/0018504 A1
(43) Pub. Date: Jan. 26, 2006

(54) Multi-layer composite material panel

(76) Inventor: Tai-Yan Kam, Hsinchu City (TW)

Correspondence Address: TRANSPACIFIC LAW GROUP, 617 NORTH DELAWARE STREET, SAN MATEO, CA, 94401, US

(21) Appl. No.: 10/897,874

(22) Filed: Jul. 22, 2004

(51) Int. Cl. H04R 25/00

(52) U.S. Cl. 381/431; 381/152

(57) ABSTRACT

The invented multi-layer composite material panel comprises a panel structure that comprises a first composite material layer, an intermediate layer and a second composite material layer in order. Both composite material layers may have same or different constituent materials and layer structures. Each composite material layer may include a fiber-reinforced resin layer and a polymeric membrane. The intermediate layer may have one or more layer of porous material. A lamination panel is fabricated by placing the first composite material layer, the intermediate layer and the second composite material layer in order and binding the layers with affixing means. The multi-layer composite material panel so fabricated is light in weight, hard and strong in structure. The invented multi-layer composite material panel is particularly useful in the application where precision control is needed, such as in the case of panel radiator for loudspeaker.

### FIELD OF THE INVENTION

The present invention relates to the structure of a multi-layer composite material panel, especially to a novel multi-layer composite material panel. The multi-layer composite material panel is particularly useful in the application of panel radiators for flat panel loudspeakers.

### BACKGROUND OF THE INVENTION

In all kinds of field where fine control is needed, selection and combination of panel materials are very important. For example, the sound radiator used in the high quality loudspeaker shall be light in weight and hard in strength, whereby highly precise, high quality and efficient loudspeaking effects may be realized. In such applications, the structure and the material of the panel are key issues to the performance of the product using the panel.

Japanese published patent application No. H1-204735 disclosed a reinforced fiber composite material. The material related to a lamination of vibration resistant fiber-reinforced composite layers such as damping material layers interlaid in layers of carbon fibers filled with resin. The material so prepared is hard and light and may be used as structural materials for satellite, OA machine, car, golf club etc.

Japanese published patent application No. H9-193296 disclosed a composite lamination panel and an outer panel material for aircraft. The invention related to a substrate structure with a titanium alloy layer and a reinforced carbon fiber layer. A plurality of such composite material layer is laminated to form a lamination panel. The panel is hard and resistant to shock.

It is necessary to provide a novel multi-layer composite material panel, that is light in weight and of greater hardness so to be used in all kinds of applications where fine control is needed.

It is also necessary to provide a multi-layer composite material panel that is easy to manufacture and strong in structure.

It is also necessary to provide a new structure for multi-layer composite material panel such that the panel is rigid, light and strong.

### OBJECTIVES OF THE INVENTION

The objective of this invention is to provide a novel multi-layer composite material panel that is light in weight and of greater hardness so to be used in all kinds of applications where precision control is needed.

Another objective of this invention is to provide a multi-layer composite material panel that is easy to manufacture and strong in structure.

Another objective of this invention is to provide a new structure for multi-layer composite material panel such that the panel is rigid, light and strong

### SUMMARY OF THE INVENTION

According to this invention, a multi-layer composite material panel is provided. The multi-layer composite material panel of this invention comprises a panel structure comprising a first composite material layer, an intermediate layer and a second composite material layer. Both composite material layers may be different in their constituent materials and layer structure. Each composite material layer may include a fiber-reinforced layer and a polymeric membrane. The intermediate layer may have one or more layers of porous materials. A lamination panel is prepared by placing the first composite material layer, the intermediate layer and the second composite material layer in order and adhering the layers with any binding means. The multi-layer composite material panel so prepare is light in weight, hard in substance and strong in structure. The invented multi-layer composite material panel is particularly useful in the application where high-level precision control is needed, such as in the case of panel radiators for flat panel loudspeaker.

These and other objectives and advantages of this invention may be clearly understood from the detailed description by referring to the following drawings.

### BRIEF DESCRIPTION OF THE DRAWINGS

FIG. 1 shows the structure of the multi-layer composite material panel of this invention.

FIG. 2a shows a sheet of composite material layer comprising a uni-axially fiber-reinforced resin layer 211 and a polymeric membrane 22.

FIG. 2b shows a sheet of composite material layer comprising a fabric-reinforced resin layer 212 and a polymeric membrane 22.

FIG. 3 shows patterns printed on the multi-layer composite material panel of this invention.

### DETAILED DESCRIPTION OF THE INVENTION

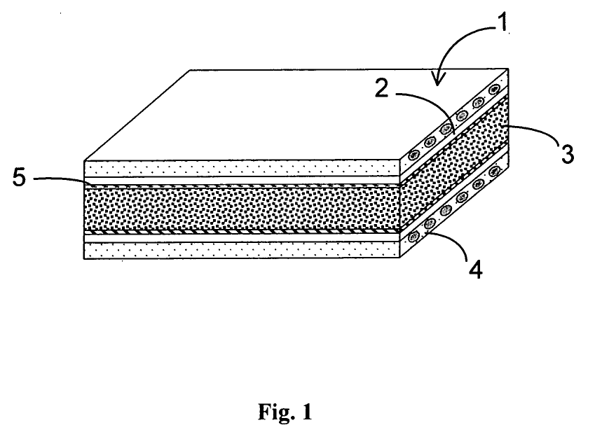

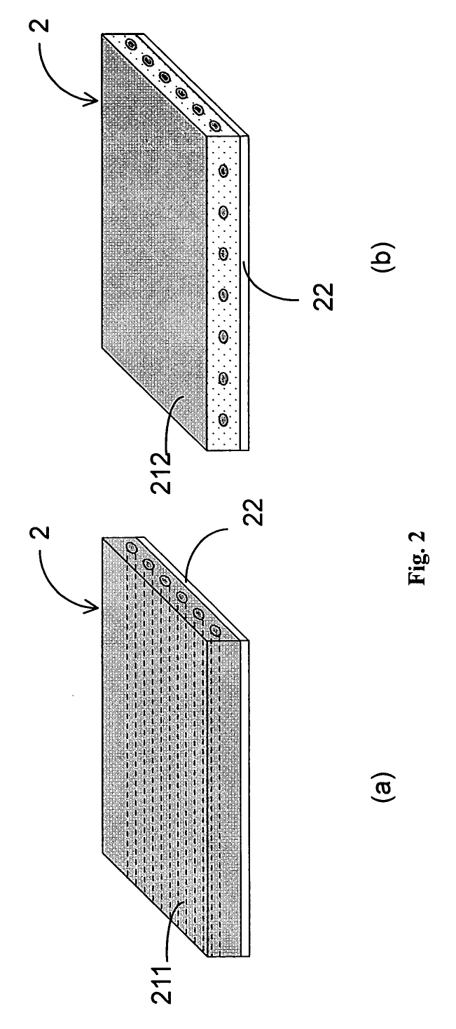

FIG. 1 shows the structure of the multi-layer composite material panel of this invention. As shown in this figure, the multi-layer composite material panel of this invention comprises a panel structure 1 with a plurality of layers. The panel structure 1 comprises a first composite material layer 2, an intermediate layer 3 and a second composite material layer 4. The composite material layers 2, 4 may have the same or different constituent materials and layer structure. As shown in FIG. 2, each of the composite material layers 2, 4 may include a fiber-reinforced resin layer 21, 41 and a polymeric membrane 22, 42. The intermediate layer 3 may have one or more layers of porous materials. The polymeric membrane layers 22, 42 of the composite material layers 2, 4 bind the composite material layers 2, 4 to the intermediate layer 3 by adhesion.

Materials suitable for the fiber-reinforced resin layers 21, 41 include materials comprising one or more layers of fiber-reinforced polymeric resin substrates. The fiber material may be at least one selected from the group of: uni-axially oriented carbon fiber, uni-axially oriented glass fiber, uni-axially oriented aramid fiber, uni-axially oriented baron fiber, carbon fiber fabric, glass fiber fabric, aramid fiber fabric, baron fiber fabric etc. Material for the polymeric resin substrate may be one selected from the group of: epoxy resin, polyester resin, poly ethylene resin, vinyl ester resin, poly propylene resin, PEEK resin, polyurethane resin, polyimide resin and the like, phenolic resin etc. It is also possible to prepare a fiber-reinforced polymeric layer by submerging fibers in polymeric resin to form a sheet of fiber-reinforced polymeric resin substrate. FIG. 2a shows a sheet of composite material layer comprising a single-layer, uni-axial fiber-reinforced resin layer 211 and a polymeric membrane 22. FIG. 2b shows a sheet of composite material layer comprising a single layer of bi-axially fiber-reinforced fabric and a polymeric membrane 22.

The polymeric membrane layers 22 and 42 are positioned between the fiber-reinforced resin layers 21, 41 and the intermediate layer 3, respectively. The material of the polymeric membrane 22, 42 may be one or more selected from the group of: polycarbonate, polyethylene, polyvinyl chloride, polyvinylidene chloride and other light-weighted and tough material or their compositions.

Although it is not intended to limit the scope of this invention, in the present invention the polymeric membrane layer is used to strengthen the toughness of the fiber-reinforced resin layer in the direction perpendicular to fiber direction, without adding unnecessary weight to the panel structure. The polymeric membrane increases the toughness of the fiber-reinforced polymeric resin substrates and protects the substrates from cracking or other similar damages induced by mechanical stresses during forming, processing or application of the panel structure, especially when the fiber-reinforced layers 21, 41 are made of a single-layer of uni-axially fiber-reinforced lamination. Another function of the polymeric membrane layer is to give enhanced adhesiveness to the interface between the first composite material layer and the intermediate layer, and the interface between the second composite material layer and the intermediate layer, so that the adhesive interfaces between the two composite material layers and the intermediate layer will not be loosen. A thin and light-weighted multi-layer composite material panel with high rigidity is thus obtained.

Method for binding the reinforced fiber layers 21, 41 to the polymeric membranes 22, 42, respectively, may be any applicable means. A popular way is to apply heat and pressure to affix the polymeric membrane to the fiber-reinforced layer to form a composite material layer. Other methods to combine the fiber-reinforced layer with the polymeric membrane are also applicable in this invention. The thickness of the polymeric membranes 22, 42 and the fiber-reinforced layers 21, 41 may be in a ratio between 1:1 to 1:8, preferably between 1:1 to 1:3.

In the embodiment of this invention, the intermediate layer 3 may be any light-weighted and hard material. Applicable material includes all kinds of natural or artificial porous structure panels, such as balsa wood, paulownia, aramid paper made honeycomb structure, aluminum foil made honeycomb structure, polystyrene formed material, polyethylene chloride formed material, polyurethane formed material, ABS formed material, polypropylene formed material and phenolic formed material. Among them, material especially suited in the application of radiating panel for loudspeaker includes: balsa wood, paulownia, polystyrene foamed material and polyethylene chloride formed material.

The thickness of the composite material layer 2, 4 and the intermediate layer 3 shall be in a proper ratio. Applicable ratio may be between 1:1 to 1:30, preferably between 1:1 to 1:10.

Adhesive 5, 5 is applied to the interfaces between the first composite material layer 2 and the intermediate layer 3, and between the second composite material layer 4 and the intermediate layer 3. The first composite material layer 2, the intermediate layer 3 and the second composite material layer 4 are piled up in order. The stack is pressed with heat to form an integrated laminated panel 1. During the hot-press curing process, if the first composite material layer 2 and the second composite material layer 4 are made of uni-axially fiber reinforced composite material, the orientations of their fibers are preferably aligned parallel or substantially parallel. If the first composite material layer 2 and the second composite material layer 4 are made of fiber fabric, the orientations of the longitudinal fibers and the transverse fibers of the first composite material layer 2 are preferably aligned parallel or substantially parallel, respectively, to those of the second composite material layer 4.

After the multi-layer composite material panel is fabricated, the panel is cut into pieces with desired size and shape. The multi-layer composite material panel of this invention is light in weight, hard and strong in structure. It may be used in all kinds of application where precision control is needed.

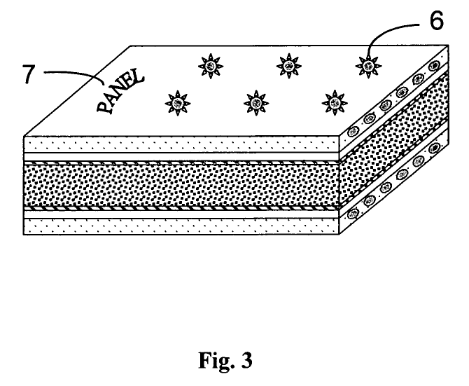

During the application of the invented multi-layer composite material panel, desired figures 6 or characters 7 may be printed on the surface of the panel, as shown in FIG. 3. In addition, it is possible to print such figures or characters on the fiber-reinforced resin layer or the polymeric membrane to form embedded patterns.

As the present invention has been shown and described with reference to preferred embodiments thereof, those skilled in the art will recognize that the above and other changes may be made therein without departing from the spirit and scope of the invention.

1. A multi-layer composite material panel radiator for loudspeaker, comprising a panel structure comprising: a first composite material layer, an intermediate layer and a second composite material layer stacked in order; wherein each said composite material layer comprises a fiber-reinforced resin layer and a polymeric membrane and wherein said intermediate layer comprises at least one porous material layer.

2. The multi-layer composite material panel according to claim 1, wherein said first composite material layer and said second composite material layer have different constituent materials and different layer structures.

3. The multi-layer composite material panel according to claim 1, wherein said composite material layers are adhered to said intermediate layer with adhesives.

4. The multi-layer composite material panel according to claim 1, wherein said fiber-reinforced resin layer comprises a layer selected from a group consisting of a single-layer, uni-axially oriented fiber layer and a single-layer fiber fabric layer.

5. The multi-layer composite material panel according to claim 1, wherein said composite material layers are adhered to said intermediate layer with their polymeric membranes facing said intermediate layer, respectively.

6. The multi-layer composite material panel according to claim 5, wherein said composite material layers are adhered to said intermediate layer with adhesives.

7. The multi-layer composite material panel according to claim 1, wherein thickness of said polymeric membrane and said reinforced fiber layer is in a ratio between 1:1 and 1:8.

8. The multi-layer composite material panel according to claim 7, wherein thickness of said polymeric membrane and said fiber-reinforced resin layer is in a ratio between 1:1 and 1:3.

9. The multi-layer composite material panel according to claim 1, wherein said fiber-reinforced resin layers comprise uni-axially oriented fiber material and orientation of fibers of said fiber-reinforced resin layers is aligned substantially parallel.

10. The multi-layer composite material panel according to claim 1, wherein said fiber-reinforced resin layers comprise fiber fabric material and orientations of longitudinal fibers and transverse fibers of said fiber-reinforced resin layers are aligned substantially parallel, respectively.

11. Method for fabricating a multi-layer composite material panel radiator for loudspeaker, comprising the following steps:
applying adhesives on a first composite material layer;
placing an intermediate layer on said first composite material layer;
placing a second composite material layer that is applied with adhesive on said intermediate layer; and
applying heat and pressure to assembly so obtained to form an integrated composite material panel;
wherein each said composite material layer comprises a fiber-reinforced resin layer and a polymeric membrane and wherein said intermediate layer comprises at least one porous material layer.

12. The method according to claim 11, wherein said first composite material layer and said second composite material layer have different constituent materials and different layer structures.

13. The method according to claim 11, wherein said composite material layers are adhered to said intermediate layer with adhesives.

14. The method according to claim 11, wherein said fiber-reinforced resin layer comprises a layer selected from a group consisting of a single-layer, uni-axially oriented fiber-reinforced resin layer and a single-layer fiber fabric-reinforced resin layer.

15. The method according to claim 11, wherein said composite material layers are adhered to said intermediate layer with their polymeric membranes facing said intermediate layer, respectively.

16. The method according to claim 11, wherein thickness of said polymeric membrane and said fiber-reinforced resin layer is in a ratio between 1:1 and 1:8.

17. The method according to claim 16, wherein thickness of said polymeric membrane and said fiber-reinforced resin layer is in a ratio between 1:1 and 1:3.

18. The method according to claim 11, wherein said fiber-reinforced resin layers comprise uni-axially oriented fiber material and orientations of fibers of said fiber-reinforced resin layers are aligned substantially parallel.

19. The method according to claim 11, wherein said fiber-reinforced resin layers comprise fiber fabric material and orientations of longitudinal fibers and transverse fibers of said fiber-reinforced resin layers are aligned substantially parallel, respectively.
